(19) United States
(12) Patent Application Publication
(10) Pub. No.: US 2019/0281045 A1
(43) Pub. Date: Sep. 12, 2019

(54) Control Of Access To Contents Which Can Be Retrieved Via A Data Network

(71) Applicant: Siemens Aktiengesellschaft, Muenchen (DE)

(72) Inventors: Joachim Walewski, Unterhaching (DE); Amine Mohamed Houyou, Muenchen (DE)

(73) Assignee: Siemens Aktiengesellschaft, Muenchen (DE)

(21) Appl. No.: 16/422,544

(22) Filed: May 24, 2019

Related U.S. Application Data
(62) Division of application No. 15/321,964, filed on Dec. 23, 2016.

(30) Foreign Application Priority Data
Jun. 25, 2014 (DE) 10 2014 212 210.4

(51) Int. Cl. H04L 29/06; H04L 29/12

(52) U.S. Cl. CPC H04L 63/0823; H04L 61/6068; H04L 61/2007; H04L 63/101; H04L 61/1511; H04L 63/0236; H04L 63/0209

(57) ABSTRACT

A method for controlling access to digital content that is retrievable via a data network comprises: receiving a registration request for a domain name to be registered by a registration authority; checking the registration request to determine whether to subject the registration request to access control based at least in part on the digital contents retrievable under the domain name; and, in response to a determination to subject the registration request to access control, allocating a first IP address and a second IP address to the domain name to be registered. The first IP address is in an address range predefined for access control.

### CROSS-REFERENCE TO RELATED APPLICATIONS

This application is a Divisional of U.S. application Ser. No. 15/321,964 filed Dec. 23, 2016, which is a U.S. National Stage Application of International Application No. PCT/EP2015/060183 filed May 8, 2015, which designates the United States of America, and claims priority to DE Application No. 10 2014 212 210.4 filed Jun. 25, 2014, the contents of each are hereby incorporated by reference in their entirety.

### TECHNICAL FIELD

The invention relates to means for controlling access to contents which can be retrieved via a data network. The invention relates, in particular, to means for controlling access to contents which are unsuitable for minors in the global data network.

### BACKGROUND

A social problem of the global data network, also called the World Wide Web, which currently cannot be completely solved arises from the possibility of accessing contents which are not suitable for minors, which access is difficult to control.

Interests of groups representing legal guardians and engaged in effectively controlling the access of minors often collide with concerns of other interest groups which see the global data network threatened by restrictions culminating in censorship measures.

Individual requests for central, that is to say national or global, access control are difficult to reconcile with a need for freedom of expression.

In addition to technically possible central access control, decentralized measures which restrict access to the global data network at a computer level are also known in the prior art, in which case filter software is run on the computer.

Such filter software is based on checking and filtering every called content, for example by resorting to a negative list or “blacklist”. Such a negative list contains a more or less large selection of domain names, Internet addresses and/or keywords to be blocked. This negative list requires continuous updating in order to provide the desired protective purpose. A further restrictive approach for configuring filter software provides a positive list or white list which is used to grant access to contents only when the corresponding domain names or Internet addresses match an entry in the positive list.

On account of the considerable dynamics of the global data network, filter software cannot ensure sufficient access control for minors, especially since access controls locally installed on a computer can be technically effortlessly circumvented by many minors.

Overall, it can be stated that the protocols currently used in the global data network do not provide a sufficient possibility for controlling access to contents of a data network which may be unsuitable for minors.

### SUMMARY

One embodiment provides a method for controlling access to contents which can be retrieved via a data network, comprising the following steps of: receiving a domain name; transmitting at least one name resolution request with respect to the domain name to a namespace directory service; receiving at least one response from the namespace directory service to the at least one name resolution request and removing at least one IP address from the at least one response; checking at least one IP address removed from the response in order to determine whether it is in an address range predefined for access control; and in the event of a positive result of the check for a removed first IP address, treating at least one second IP address from the removed IP addresses as access-controlled.

Another embodiment provides a method for controlling access to contents which can be retrieved via a data network, comprising the following steps of: receiving an IP address; transmitting at least one access request with respect to the IP address; receiving at least one response to the at least one access request and removing at least one IP address from the at least one response; checking at least one IP address removed from the response in order to determine whether it is in an address range predefined for access control; in the event of a positive result of the check for a removed first IP address, treating at least one second IP address from the removed IP addresses as access-controlled.

In one embodiment, the IP addresses are configured according to version IPv6 of the Internet protocol.

In one embodiment, the first IP address in an address range predefined for access control is not significantly correlated with the second IP address which is outside the address range predefined for access control.

In one embodiment, the address range predefined for the access control is hierarchically structured.

In one embodiment, an inverse name resolution request with a statement of an IP address is rejected by a namespace directory service at least for the case in which the stated IP address is in the address range predefined for access control.

Another embodiment provides an arrangement for performing the disclosed method, comprising a blocking apparatus which is used to block a call of the IP address to be treated as access-controlled on a computer system.

Another embodiment provides a method for controlling access to contents which can be retrieved via a data network, comprising the following steps of: receiving a registration request for at least one domain name to be registered by means of a registration authority; checking the registration request in order to determine whether it is intended to be subject to access control at least on account of the contents which can be retrieved under the domain name; and in the event of a positive result of the check, allocating at least one first IP address and at least one second IP address to the domain name to be registered, the first IP address being in an address range predefined for access control.

In one embodiment, an allocated IP address is sent to a registration requester with a certificate.

In one embodiment, the authenticity of the allocated IP address is checked by the registration requester by verifying the certificate which has been sent using a public key which can be retrieved from the registration authority.

In one embodiment, at least one IP address is allocated only after a registration requester has been authorized.

### BRIEF DESCRIPTION OF THE DRAWINGS

Example aspects and embodiment are explained in detail below with reference to the drawings, in which:

FIG. 1 shows a schematic illustration of a network environment for carrying out one embodiment of the invention; and

FIG. 2 shows a schematic illustration of a plurality of address ranges inside an IP address space.

### DETAILED DESCRIPTION

Embodiments of the invention provide systems and methods for controlling access to contents which can be retrieved via a data network, which means can be achieved, on the one hand, without checking comprehensive and disjointed references to access-restricted contents and, on the other hand, is not accessible to central censorship measures.

Some embodiments provide a method for controlling access to contents which can be retrieved via a data network, according to which the following method steps are carried out. In a first step, a domain name is received. A domain name comprises, for example, a web address which is in the form www.example.org, for example. Moreover, the domain name is received at a largely arbitrary point inside the data network, for example on a browser of a local computer system, where the domain name is usually input to an address line.

In a subsequent step, a name resolution request is made with respect to the domain name and is transmitted to a namespace directory service. Name resolution is understood as meaning a method which is used to convert domain names, that is to say names of computers or services, into an IP address. Name resolution according to a service called “Domain Name System” or DNS is only one example of such name resolution. Alternatively, methods in which name resolution inside a computer system or else name resolution in an intranet is carried out with corresponding localization of the namespace directory service are also known and can be used.

In a subsequent step, at least one response from the namespace directory service to the at least one name resolution request is received. At least one IP address is removed from the response. A response containing a plurality of IP addresses is known in the current prior art, for example for the situation in which a logical server service represented by a domain name is distributed among a plurality of physical servers with accordingly different IP addresses.

In a subsequent step, at least one IP address removed from the response is checked in order to determine whether it is in an address range predefined for access control. Providing an address range predefined for access control within the complete available address space for IP addresses concerns one idea of the invention with regard to segmentation of a “critical” address range, that is to say in said address range predefined for access control, and a “non-critical” address range, that is to say in an address range outside the critical address range.

In the event of a positive result of the check for a removed first IP address, at least one second IP address from the removed IP addresses is treated as access-controlled. In other words, a positive result of the check means that at least one IP address removed from the response is in a “critical” address range predefined for access control.

Embodiments of the invention are based on the fundamental approach that an IP address is transmitted in any case in response to a name resolution request. However, if a name resolution request is made for a domain name which is marked by the namespace directory service with access control, a “tag” is sent with the IP address, which tag indicates that the contents which can be retrieved under this domain on the requesting computer system should be subject to access control, for example because said contents contain parts which are unsuitable for minors.

Embodiments of the invention provide for this tag to be provided in the form of an IP address. This provision has a plurality of advantages. On the one hand, transmission of an IP address does not require any changes to the common name resolution and transmission protocols. Furthermore, tagging with an IP address is independent of transport mechanisms such as TCP and also Internet protocols, for example HTTP and FTP. A level of the IP addresses is therefore a lowest common denominator for a multiplicity of Internet mechanisms and protocols. On the other hand, an IP address can be structured in a hierarchical manner and allows a faster check in order to determine whether a particular IP address is in a particular address range. Such a check can be provided in a quick manner on a local computer system or else on an upstream system on the communication path between the namespace directory service and the local computer system. The practice of determining whether a particular IP address is in a particular IP address range can be carried out more quickly, in particular, than a comparison of a particular IP address with a predefined list of IP addresses. This slower comparison is used in the prior art of a positive list or white list which is used to determine whether a particular IP address matches an entry in the positive list.

Some embodiments provide an arrangement for performing the disclosed method using a blocking apparatus which is used to block a call of the IP address to be treated as access-controlled on a computer system.

One embodiment provides a method for controlling access to contents which can be retrieved via a data network, according to which the following method steps are carried out. In a first step, an IP address is received, for example by a user's input on a browser of a local computer system, where an IP address can be input in an address line. In a subsequent step, an access request is made with respect to the IP address. In a subsequent step, at least one response to the at least one access request is received. At least one IP address is removed from the response. In a subsequent step, at least one IP address removed from the response is checked in order to determine whether it is in an address range predefined for access control. As explained above, providing an address range predefined for access control within the complete available address space for IP addresses is used for segmentation of a “critical” address range, that is to say in said address range predefined for access control, and a “non-critical” address range, that is to say in an address range outside the critical address range. In the event of a positive result of the check for a removed first IP address, at least one second IP address from the removed IP addresses is treated as access-controlled. In other words, a positive result of the check means that at least one IP address removed from the response is in a “critical” address range predefined for access control. The IP address received according to the first step can moreover be identical to one of the returned IP addresses.

One embodiment provides a method for controlling access to contents which can be retrieved via a data network, according to which the following method steps are carried out. After receiving a registration request for at least one domain name to be registered by means of a registration authority, the registration request is checked in order to determine whether it is intended to be subject to access control at least on account of the contents which can be retrieved under the domain name. Such a check also includes situations in which the registration requester outputs clarification, according to which its retrievable contents should be at least partially subject to access control, whereupon the access control is allocated without a substantial check. A registration authority can be understood as meaning an organization which registers a domain name on request and assigns IP addresses to this domain name.

In the event of a positive result of the check, at least one first IP address and at least one second IP address are allocated to the domain name to be registered, the first IP address being in an address range predefined for access control.

It is also possible to check whether retrievable contents are intended to be subject to access control after the registration request has been concluded. If such a check reveals, where a domain name has already been registered, that contents which can be retrieved under this domain are intended to be subject to access control, at least one first IP address is added to the already existing second IP address, the first IP address being in an address range predefined for access control. The second IP address is the already existing IP address under which a server for retrieving contents of the domain is offered.

According to one embodiment, the IP addresses are configured according to version IPv6 of the Internet protocol. This configuration ensures that the address space which is available overall, in particular the address range predefined for access control, is large enough to address a sufficient number of domains.

Another embodiments provide for the first IP address, that is to say that IP address which is in an address range predefined for access control, to not be significantly correlated with the second IP address, that is to say that IP address which is outside the address range predefined for the access control. This measure ensures that it is not possible to restrict access, for example by means of national firewalls. This is because the invention is intended to ensure that access is controlled on a local computer system or on a server connected upstream of the local computer system and is not controlled by regionally comprehensive or national censorship, for instance. This aim is supported by non-correlated allocation of the first and second IP addresses.

Another embodiment provides for the address range predefined for access control to be hierarchically structured. In this respect, it can be stated that IP addresses are particularly suitable for creating hierarchical trees. A hierarchical configuration of the IP addresses therefore makes it possible to grade access-controlled contents. With regard to the inventive motivation, a graded age rating of access-controlled contents would be conceivable, for example. Such a measure also provides possibilities for search optimization for search engine operators specializing in access-controlled contents. The advantages according to the invention which result in better filtering of access-controlled contents can also be used to automatically search for access-controlled content.

Another embodiment provides for an inverse name resolution request with a statement of an IP address to be rejected by a namespace directory service at least for the case in which the stated IP address is in the address range predefined for access control.

This configuration ensures that inverse requests with the aim of inferring a relationship between the first “critical” IP address in an address range predefined for access control and the second IP address are rejected and/or are not answered. This configuration therefore constitutes a further measure for making national censorship attempts difficult.

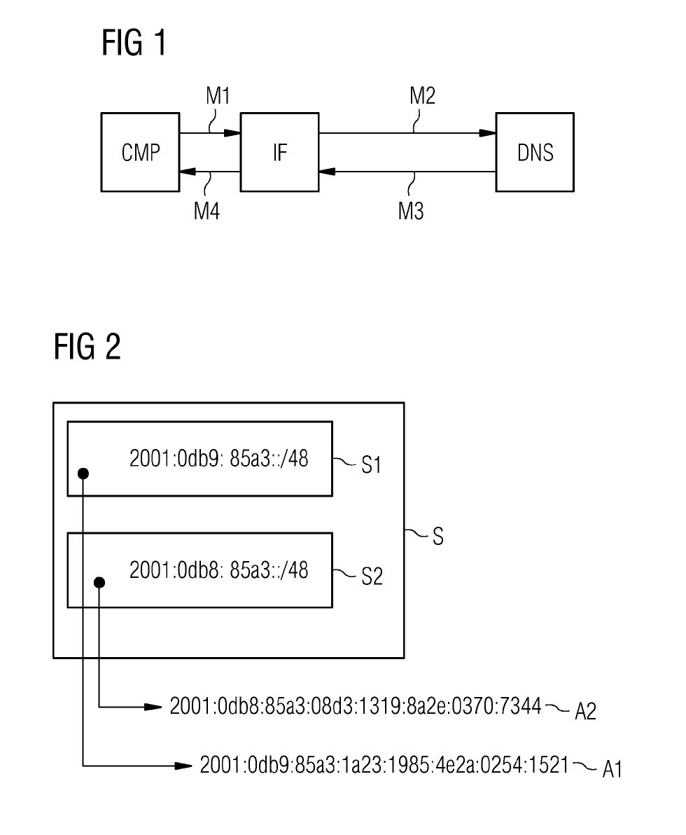

FIG. 1 shows a computer system CMP having an interface IF to a namespace directory service DNS. The interface IF is configured either inside the computer system, for example as a network interface of the computer system CMP, or outside the computer system, for example as a proxy computer.

A domain name is received on the computer system CMP, in particular in a service (not illustrated) running there, for example a browser. The domain name is transmitted to the namespace directory service DNS as part of a name resolution request. For this purpose, a message M1 containing the domain name is transmitted from the computer system CMP to the interface IF and is forwarded by the latter with a name resolution request message M2.

Any desired further network devices or network segments may also be located on the message path of the messages M1, M2. In particular, the message path of the messages M1, M2 also comprises the global data network or World Wide Web.

The namespace directory service responds with a message M3 which is received by the interface IF and is forwarded to the computer system CMP as a response M4. At least one IP address is removed from the at least one response M3, M4 on the computer system CMP or already in the interface IF.

The interchange of messages described above can also be carried out sequentially and, in particular, with the involvement of a plurality of returned IP addresses. For this purpose, the namespace directory service DNS returns a list of a plurality of IP addresses for a requested domain name.

The principle of repeatedly returning IP addresses in a list can also be expanded as follows. For example, namespace directory services DNS are known which re-sort the IP addresses in the list of a plurality of IP addresses according to the request, in particular on the basis of the source IP address of the requesting computer system. It is then possible to move an entry which is adjacent in terms of the network upward, for example using “GeoDNS”.

If a plurality of servers which all provide the same information can be reached in a network segment under an identical domain name, it is known practice, for reasons of load distribution or for reasons of ensuring availability, to distribute the access operations among different servers by moving a respective IP address in the returned list upwards.

At least one response M3, M4 from the namespace directory service DNS to the at least one name resolution request M1, M2 is received at the interface IF or at the computer system CMP. At least one IP address is removed from the response M3, M4.

The invention uses the above-described principle of repeatedly returning IP addresses, in particular for the situation in which one or more IP addresses which address the target server are accompanied by an IP address in an address range predefined for access control. Accordingly, a check is now carried out at the interface IF or at the computer system CMP itself in order to determine whether at least one IP address removed from the response is in an address range predefined for access control. If this is the case, that is to say if there is a positive result of the check for a removed IP address—now called the “first” IP address, at least one further IP address—called the “second” IP address below—from the removed IP addresses is treated as access-controlled. In this case, it is the responsibility of an administrator of the computer system or an administrator of an interface IF in the form of a proxy or a gateway, for example, to determine whether access to contents of a server assigned to the second or the first IP address is denied, for example in order to protect minors.

Providing an address range predefined for access control within the complete available address space for IP addresses concerns a core idea of the invention with regard to segmentation of a “critical” address range, that is to say in said address range predefined for access control, and a “non-critical” address range, that is to say in an address range outside the critical address range.

In the event of a positive result of the check for a removed first IP address, at least one second IP address from the removed IP addresses is treated as access-controlled. In other words, a positive result of the check means that at least one IP address removed from the response is in a “critical” address range predefined for access control.

According to another embodiment, direct access to access-restricted contents, which could be achieved by inputting the IP address of the access-restricted contents, is prevented. The corresponding method is explained with further reference to FIG. 1.

An IP address is received on the computer system CMP, in particular in a service (not illustrated) running there, for example a browser. The computer system CMP transmits an access request M1 containing the IP address to the interface IF. In an access checking unit (not illustrated), an access check of the requested IP address is carried out in order to determine whether access control exists for said address.

The access checking unit can be implemented either in the interface IF or else in the computer system CMP itself. For the access check itself, the access checking unit can access further decentralized entities (not illustrated), for example can also send a request to a service assigned to the namespace directory service DNS.

At least one IP address is removed from the at least one response M4 to the access request M1 on the computer system CMP. In a subsequent step, at least one IP address removed from the response is checked in order to determine whether it is in an address range predefined for access control.

As explained above, providing an address range predefined for access control within the complete available address space for IP addresses is used for segmentation of a “critical” address range, that is to say in said address range predefined for access control, and a “non-critical” address range, that is to say in an address range outside the critical address range.

In the event of a positive result of the check for a removed first IP address, at least one second IP address from the removed IP addresses is treated as access-controlled. In other words, a positive result of the check means that at least one IP address removed from the response is in a “critical” address range predefined for access control. The IP address received according to the first step may also be identical to one of the returned IP addresses.

Embodiments of the invention are based on the fundamental approach that an IP address is transmitted in any case in response to a name resolution request or in response to an access request with respect to an IP address. If an access request is made for an IP address or a name resolution request is made for a domain name which is marked by the namespace directory service, for example, with access control, a “tag” is sent with at least one returned IP address, which tag indicates that the contents which can be retrieved under this domain on the requesting computer system should be subject to access control, for example because said contents contain parts which are unsuitable for minors.

The invention provides for this tag to be in the form of an IP address. The use of an IP address for this purpose has a plurality of advantages. On the one hand, transmission of an IP address does not require any changes to the common name resolution and transmission protocols. Furthermore, use of an IP address is independent of the selected transport and Internet protocol. Finally, an IP address can be structured in a hierarchical manner and allows a faster check in order to determine whether a particular IP address is in a predefined address range. Such a check can be provided in a quick manner on a local computer system or else on an upstream system on the communication path between the namespace directory service and the local computer system. The practice of determining whether a particular IP address is in a predefined IP address range can be carried out more quickly, in particular, than a comparison of a particular IP address with a predefined list of “disjointed” IP addresses. This slower comparison is used in the prior art of a positive list or white list which is used to determine whether a particular IP address matches an entry in the positive list.

In the exemplary embodiments described here, reference is made to contents which can be retrieved via a data network and which are unsuitable for minors but are not subject to any legal restrictions for adults. It is therefore assumed that the provider of the contents supports, or at least tolerates, the methods described in the exemplary embodiments in the interests of protecting minors.

The exemplary embodiments do not relate to contents which can be retrieved and the dissemination or reception of which is generally illegal. It can generally always be assumed that the provider of such contents does not support methods in the interests of protecting minors.

FIG. 2 shows a schematic illustration of a plurality of address ranges within an IP address range. The notation of illustrated IP addresses and IP address ranges corresponds to version IPv6 of an Internet protocol.

An IP address space S comprises two IP address ranges S1, S2 which are within the IP address space S and are mutually disjointed. A first “critical” address range S1, that is to say an address range predefined for access control, comprises a range of 2001:0db9: 85a3::/48. A second address range S2 outside the first address range comprises a range of 2001:0db8: 85a3::/48.

Providing an address range S1 predefined for access control within the complete available address space S for IP addresses concerns one idea of the invention with regard to segmentation of a “critical” address range S1, that is to say in the address range predefined for access control, and a “non-critical” address range S2, that is to say in an address range outside the critical address range S1.

The second IP address A2 with the value 2001:0db8:85a3:08d3:1319:8a2e:0370:7344 is determined below as the result of a name resolution of an exemplary domain name www.example.org by the namespace directory service DNS. As illustrated in the drawing, the second IP address A2 is inside the second address range S2.

The second IP address A2 is the IP address under which a server for retrieving contents of the domain www.example.org is offered.

It goes without saying that, in addition to a known application protocol HTTP (Hypertext Transfer Protocol), such an offer may also comprise further application protocols, for example FTP, IMAP, HTTPS etc, for retrieving websites.

The domain name www.example.org is now classified as “critical” on the basis of entries in the namespace directory service DNS itself or on the basis of a request from the namespace directory service DNS to a server (not illustrated). Therefore, this second IP address A2 is sent together with a “critical” first IP address A1 which is likewise assigned to this domain name www.example.org and has the value 2001:0db9:85a3:1a23:1985:4e2a:0254:1521.

The first IP address A1 returned by the namespace directory service DNS is in an address range S1 predefined for access control, as illustrated in the drawing. Both IP addresses A1, A2 are global unicast addresses.

With use of the means according to the invention, there is advantageously no need to check currently known filter software, in order to determine whether a domain to be called could be “critical”, in favor of a simple statement that access is effected with transmission of a “critical” first IP address A1 which is also assigned.

The address range S1 predefined for access control is advantageously managed by a registration authority or a similar central entity with which content providers can register a domain name with a registration request. Such a registration authority can also be an Internet service provider or ISP entrusted with allocating domains by a central entity.

In this case, registration comprises receiving a registration request for at least one domain name to be registered by means of the registration authority. The registration request is checked in order to determine whether it is intended to be subject to access control at least on account of the contents which can be retrieved under the domain name. Such a check also includes situations in which the registration requester outputs clarification, according to which its retrievable contents should be subject to access control, whereupon the access control is allocated without a substantial check. In the event of a positive result of the check, at least one first IP address and at least one second IP address are allocated to the domain name to be registered, the first IP address being in an address range predefined for access control.

During this allocation of IP addresses, it is also possible to create a certificate for an authenticity check. This then allows the check in order to determine whether the IP address is correctly acquired or the ownership is only predefined.

In order to avoid a solution on a plurality of network layers, one configuration proposes a certificate which is stored as a checksum in an option field of an IPv6 header.

This checksum is, for example, the result of an encryption operation during which the IPv6 address itself or a hash value produced from the latter is applied to a private key of the above-mentioned registration authority. The hash value may be valid only for a predefined time window, for example.

A user can use the public key of the registration authority to check a validity of the IP address. Authorization can also be carried out during allocation. For example, it is possible to carry out an age check, possibly with the involvement of a third-party service.

What is claimed is:

1. A method for controlling access to digital content that is retrievable via a data network, the method comprising:
receiving a registration request for a domain name to be registered by a registration authority;
checking the registration request to determine whether to apply access control based at least in part on the digital contents retrievable under the domain name; and
in response to a determination to subject the registration request to access control, allocating a first IP address and a second IP address to the domain name to be registered;
wherein the first IP address is in an address range predefined for access control.

2. The method of claim 1, further comprising sending at least one allocated IP address and a certificate corresponding to the at least one allocated IP address to a source of the registration request.

3. The method of claim 2, wherein the registration requester checks an authenticity of the at least one allocated IP address by verifying the certificate using a public key retrieved from the registration authority.

4. The method of claim 1, wherein the first IP address and the second IP address are allocated only authorizing a registration requester.

5. The method of claim 1, wherein the first IP address and the second IP address are configured according to version IPv6 of the Internet protocol.

6. The method of claim 1, wherein the first IP address is not correlated with the second IP address.

7. The method of claim 1, wherein the predefined address range for access control is hierarchically structured.

8. The method of claim 1, wherein, for a particular IP address in the address range predefined for access control, an inverse name resolution request with a statement of the particular IP address is rejected by a namespace directory service.

9. A computer system for controlling access to digital content that are retrievable via a data network, the arrangement comprising:
at least one processor; and
computer instructions stored in non-transitory computer-readable media and executable by the at least one processor to:
receive a registration request for a domain name to be registered by a registration authority;
check the registration request to determine whether to apply access control based at least in part on the digital contents retrievable under the domain name; and
in response to a determination to subject the registration request to access control, allocating a first IP address and a second IP address to the domain name to be registered;
wherein the first IP address is in an address range predefined for access control.
